(19) United States
(12) Patent Application Publication
(10) Pub. No.: US 2018/0220292 A1
(43) Pub. Date: Aug. 2, 2018

(54) Blockchain-Based Subscription Management

(71) Applicant: SAP SE, Walldorf (DE)

(72) Inventor: Dennis Landscheidt, Mannheim (DE)

(21) Appl. No.: 15/419,543

(22) Filed: Jan. 30, 2017

(51) Int. Cl. H04W 8/18; H04L 29/08; G06F 17/30; H04L 29/06; G06F 21/62

(52) U.S. Cl. CPC H04W 8/183; H04L 67/1097; G06F 21/6227; H04L 63/08; G06F 17/30312

(57) ABSTRACT

A subscription management application having a persistency layer and an API layer initiates a subscription transaction. The persistency layer is configured to store information about a subscription associated with the subscription transaction originating from a subscription blockchain. The API layer is configured to retrieve information from the subscription blockchain and to update the subscription blockchain in connection with the subscription transaction. After, the persistency layer of the subscription management application is accessed to determine, in real-time, whether the initiated subscription transaction can be completed. The subscription transaction is then completed if it is determined that the initiated subscription can be completed or it is aborted if it is determined that the initiated subscription cannot be completed. Related apparatus, systems, techniques and articles are also described.

### TECHNICAL FIELD

The subject matter described herein relates to the use of a blockchain in connection with management of subscriptions such as telecommunications subscriptions.

### BACKGROUND

A blockchain is a distributed database that maintains a continuously-growing list of ordered records called blocks. Each block contains a timestamp and a link to a previous block and can specify one or more related events. Once created, blocks cannot be modified. Such an arrangement has led to blockchains being adopted for use in various types of industries and applications that can benefit from the use of a decentralized digital ledger.

### SUMMARY

In one aspect, a subscription management application initiates a subscription transaction. The subscription management application includes a persistency layer and an application programming interface (API) layer. The persistency layer is configured to store information about a subscription associated with the subscription transaction originating from a subscription blockchain. The API layer is configured to retrieve information from the subscription blockchain and to update the subscription blockchain in connection with the subscription transaction. After the subscription transaction has been initiated, the persistency layer of the subscription management application is accessed to determine, in real-time, whether the initiated subscription transaction can be completed. The subscription transaction is then completed if it is determined that the initiated subscription can be completed or it is aborted if it is determined that the initiated subscription cannot be completed.

The subscription blockchain can be updated after the completion of the subscription transaction to reflect completion of the subscription transaction.

Each block of the blockchain after an initial block can have a hash or a reference to a hash of an immediately previous block in the block chain.

The subscription management application can access, by way of the API layer, a plurality of APIs of the blockchain to update the persistency layer with subscription information.

The persistency layer can indicate a current balance for an account associated with the subscription, a status of an account associated with the subscription, and/or an authorization for an account associated with the subscription.

The persistency layer can provide access to at least one database storing a plurality of tables with each table characterizing at least one related subscription transaction.

The subscription transaction can be associated with the use of a mobile phone to initiate a phone call over a wireless communications network. With such variations, the subscription transaction comprises data use by a mobile phone over a wireless communications network and/or initiating a message by a mobile phone over a wireless communications network.

Non-transitory computer program products (i.e., physically embodied computer program products) are also described that store instructions, which when executed by one or more data processors of one or more computing systems, cause at least one data processor to perform operations herein. Similarly, computer systems are also described that can include one or more data processors and memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter provides enhanced techniques for utilizing blockchains while providing real-time approval/information required for transactions. In particular, the current subject matter can provide software-based subscription management for the telecommunications industry that obviates the need for physical SIM cards.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a computing architecture for implementing a subscription management application utilizing a blockchain; and

FIG. 2 is a process flow diagram illustrating subscription management using a blockchain; and

FIG. 3 is a logic diagram illustrating a computing device for implementing aspects of the current subject matter.

### DETAILED DESCRIPTION

The current subject matter is directed to innovations for managing subscriptions and various services using blockchains. While the following makes reference to various telecommunications subscriptions and services such as (i) network access to network providers (i.e., verification of access, etc.), (ii) financials/payments (e.g., management of prepaid balances, etc.), and (iii) value added services/M2M communications, it will be appreciated that the current subject matter, unless otherwise specified, is applicable to other types of subscription and/or service management (for instance cloud subscriptions or subscriptions in utilities).

Currently, phone manufacturers sell mobile phones and telecommunications companies manage the mobile service subscriptions by providing physical subscriber identity module (SIM) cards. Further, network providers, which can be separate and distinct from the telecommunications providers, can provide the physical infrastructure to enable mobile phone calls and/or data transfer by mobile phones.

Newer phones are increasingly using software-based SIMs. By leveraging software-based SIMs, the current subject matter provides a blockchain-based subscription management arrangement that allows for the management of subscriptions by a wider range of entities including phone manufacturers, telecommunications providers, network providers, and third party vendors.

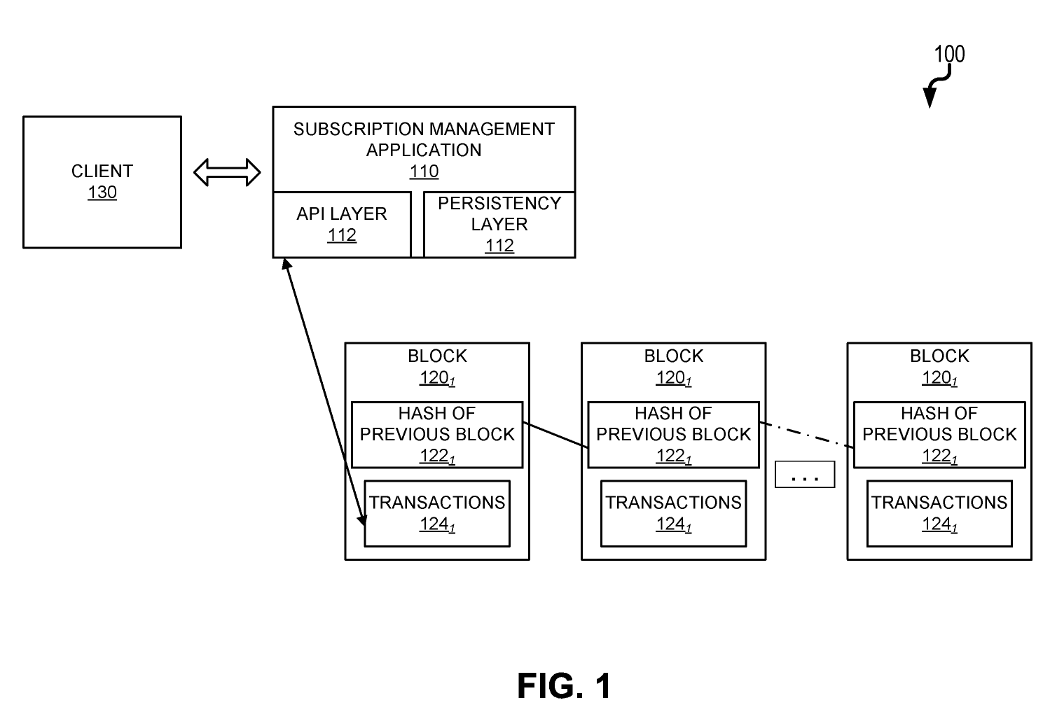

FIG. 1 is a diagram 100 illustrating a subscription management application 110 that utilizes a blockchain 120. The blockchain 120 comprises blocks 122_{1 . . . n} that hold batches of valid transactions 126_{1 . . . n}. Each block 122_{1 . . . n} includes a hash 124_{1 . . . n} of the prior block in the blockchain 120 linking these two blocks. The linked blocks 122_{1 . . . n} together form a chain. In addition to a secure hash based history, a blockchain 120 can include one or more algorithms for scoring different versions of the history so that one with a higher value can be selected over others. Peers supporting the database do not have exactly the same version of the history at all times, rather they keep the highest scoring version of the database that they currently know of. Whenever a peer receives a higher scoring version (usually the old version with a single new block added) they extend or overwrite their own database and retransmit the improvement to their peers. There is never an absolute guarantee that any particular entry will remain in the best version of the history forever, but because blockchains are typically built to add the score of new blocks onto old blocks and there are incentives to only work on extending with new blocks rather than overwriting old blocks, the probability of an entry becoming superseded goes down as more blocks are built on top of it, eventually becoming very low.

To enable all of the above points, adaptations to blockchain by introducing a subscription management application 110 accessed by a client 130 (which can be a computing device such as a mobile phone) together with specific interfaces (API) are required. The technical specifics will be explained in the following paragraphs.

Each block 122_{1 . . . n} can comprise a plurality of fields. A first field can be a block size which specifies a size of the block which can, for example, have a 4 byte size. A second field can be block header which can, for example, have an 80 byte size. A third field can be a transaction counter that specifies how many transactions follow and it can, for example, have a variable size (e.g., 1-9 bytes, etc.). A fourth field can encapsulate transactions recorded in the block 122_{1 . . . n} and can have a variable size to accommodate various types/sizes of transactions.

The block header, which forms a field in the block 122_{1 . . . n} can also include a plurality of fields that characterize the block 122_{1 . . . n} and/or the blockchain 120. A first field can specify a version of the software management application 110 or other software or other protocol and can, for example, have a 4 byte zie. A second field can include a previous block hash which is a reference to the hash of the previous/parent block 122_{1 . . . n} in the blockchain 120. The second field can, for example, have a 32 byte size. The third field can, for example, be a Merkle root which is a hash of the root of the Merkle tree of the transactions for the block 122_{1 . . . n}. The third field can, for example, have a 32 byte size. The fourth field can be a timestamp which is the approximate creation time for the block 122_{1 . . . n} and can, for example, have a size of 4 bytes. The fifth field can characterize a difficult target for the a proof-of-work algorithm as applied to the block 122_{1 . . . n} The fifth field can, for example, have a size of 4 bytes. A sixth field can be a nonce which is a counter used for the proof-of-work algorithm and can have a size of 4 bytes.

The subscription management application 110, in response to a request from the client 130, can initiate and construct transactions that update the blockchain 120, but it also allows for balance, status and authorization approvals as part of subscription management. The subscription management application 110 can provide for fast retrievals of relevant information.

As an example, Example: A wants to call B. Before the call is established, the subscription management application is required to a) provide the balance (must be higher than zero), check the status of the subscription (e.g. active and not blocked), and check the subscribed service(s) (e.g. is A allowed to make phone calls or can A only use data). As this needs to happen in real-time, the blockchain cannot be retrieved directly due to latency. Once A is authorized by the subscription management application 110 to call B, the call takes place. After the call, the balance has to be updated and for doing so the subscription management application 110 is used to construct a transaction that then updates the blockchain and the blocks (see above).

The subscription management application 110 can allow the management of subscriptions based on blockchain technology, for instance for the telecommunications industry. It ensures all real-time requirements, while it still uses the blockchain 120 and all its advantages to store transactions.

The subscription management application 110 can include a persistency layer 112 and an application programming interface (API) layer 114. The persistency layer 112 can store selected information of each transaction and blocks 122_{1 . . . n} so that they can be used to retrieve information about each subscription in real-time. The information is also used to build up a transaction that can be used to update the blockchain 120. The API layer 114 can comprise one or more APIs that are required to retrieve information of a subscription and update the blockchain 120.

The persistency layer 110 can be a table or group of tables stored in a database (or distributed amongst multiples nodes of a distributed database) that contains relevant information in a plurality of records. Each record of such table or tables can, in turn, have a plurality of fields. A first field can be an identifier (ID) that specifies a chronological ID and which can, for example, have a size of 4 bytes. A second field can be a Mobile Station International Subscriber Directory Number (MSISDN)/phone number which can, for example, be 16 bytes. A third field can, for example, comprise a block hash of the latest block 122 in the blockchain 120. The third field can, for example, be 32 bytes long. The fourth field can, for example, be a previous block hash which is a reference to the hash of the previous block 122 in the blockchain 122 and it can also have a size of 32 bytes. A fifth field can specify services associated with the subscription (and can have a size, for example, of 80 bytes). The subscribed services in this field can define the various entitlements of the subscription (e.g., text messaging, data capabilities, international calling, data tethering, etc.). A sixth field can specify a current balance (e.g., currency amount remaining, text messages remaining, etc.) and can, for example, be 4 bytes. A seventh field can provide status information associated with the subscription and, can, for example, be 4 bytes in size. Lastly, an eighth field can be a timestamp of the table entry and, which can, for example, be 4 bytes in length. The record in the database having a highest chronological ID represents that latest status of the subscription and it keeps the latest balance. This record reflects partial information from the blockchain.

The API layer 120 can include multiple APIs to the blockchain 120 for subscription handling. These APIs can, for example, be used to obtain information or to update the blockchain, such as change balance, retrieve subscription, retrieve balance, check subscription status, check allowed usage, create subscription, and/or change subscription.

The change balance API can be used to change a balance associated with the subscription. For example, the balance of a pre-paid phone plan can be updated after completion of a phone call. This typically means reducing a balance of

Change Balance API.

This API changes a balance and consists of one methods with multiple sub-methods.

Method: CHANGE_BALANCE

Parameters: [SUBSCRIPTION]; [MSISDN]; [AMOUNT]; [TARGET]

Return Parameters: [IVIES SAGE]

The logic requires a number of sub-methods that could look as follows.

| 1. CONSTRUCT_TRANSACTION { | |
|---|---|
| Obtain latest blockchain balance and related block hash from persistency layer | |
| 112; | |
| Retrieve authorization details (possible in various ways); | |
| Define [TARGET] (which can include a mapping); [Target] is the block 122 | |
| and chain of blocks that will need to be found. | |
| } | |
| 2. UPDATE_BLOCKCHAIN { | |
| Call standard APIs for blockchain 120, for instance: | |
| http://192.168.0.1/$guid/payment?password=$passord | |
| &to=$address&amount=$amount&from=$from | |
| $password | |
| $to | |
| $amount | |
| $from | |
| 3. RECEIVE_RESPONSE_FROM_BLOCKCHAIN { | |
| Retrieve standard response from blockchain 120, for instance: | |
| { “Response Message” , “Transaction Hash”, “Notice” } | |
| { “Response Message” : “Sent to ABC”, “Transaction Hash” : | |
| “d723d02dd987z8baad95444z8877h3f76232j1234234ga998u862a3a56e11b0e” , | |
| “Notice” : “Balance updated” } | |
| } | |
| 4. UPDATE_PERSISTENCY_LAYER { | |
| Create a new record in table in the persistency layer 122 as follows: | |
| Field | Value |
| ID | ID++ |
| Subscription ID | Copy from previous entry |
| MSISDN | Copy from previous entry |
| Block Hash | Returned hash from transaction |
| Previous Block Hash | Block hash from previous entry |
| Services | Copy from previous entry |
| Balance | Difference between balance from |
| | previous entry and amount |
| Status | Copy from previous entry |
| Timestamp | Current date and time |

```
    }
    5. SEND_RESPONSE {
    Send response back to via API layer 114 (e.g., a message stating “balance
successfully updated”, etc.).
    }
```

Retrieve Balance API.

This API returns the balance of a subscription and can include a method: RETRIEVE BALANCE.

Method: RETRIEVE BALANCE

Parameters: [SUBSCRIPTION]; [MSISDN]

Return Parameters: [BALANCE]

Logic: select [BALANCE] from SUB_APP where SUB_APP.ID=SUBSCRIPTION

Check Subscription Status API.

This API returns the status of a subscription (e.g. active, blocked etc.) and can include a method RETRIEVE_STATUS.

Method: RETRIEVE_STATUS

Parameters: [SUBSCRIPTION]; [MSISDN]

Return Parameters: [STATUS]

Logic: select [STATUS] from SUB_APP where SUB_APP.ID=SUBSCRIPTION

Check Allowed Usage API.

This API returns information characterizing what types of services are allowed for the subscription and can include a method CHECK_ALLOWED_SERVICE.

Method: CHECK_ALLOWED_SERVICE

Parameters: [SUBSCRIPTION]; [MSISDN]

Return Parameters: [ARRAY of SERVICES]

Logic: select [ARRAY of SERVICES] from SUB_APP where SUB_APP.ID=SUBSCRIPTION

Create Subscription API.

This API can be used to create a new subscription in the subscription management application 110 and the according blockchain 120 and can include a method CREATE_SUBSCRIPTION.

Method: CREATE_SUBSCRIPTION

Parameters: [MSISDN]; [SERVICES]; [STATUS]; [BALABNCE]

Return Parameters: [SUBSCRIPTION_ID]; [MESSAGE]

Logic: create initial entry in persistency layer 112 and build up a blockchain 120 for newly created subscription using blockchain APIs.

Change Subscription API. This API updates status and/or services of an existing subscription in the subscription management application 110 and can include a method CHANGE_SUBSCRIPTION.

Method: CHANGE_SUBSCRIPTION

Parameters: [SUBSCRIPTION_ID]; [SERVICES]; [STATUS]

Return Parameters: [MESSAGE]

Logic: update status and/or services in the persistency layer based on the subscription_id. Potentially evaluate business rules (e.g. are changes of services allowed).

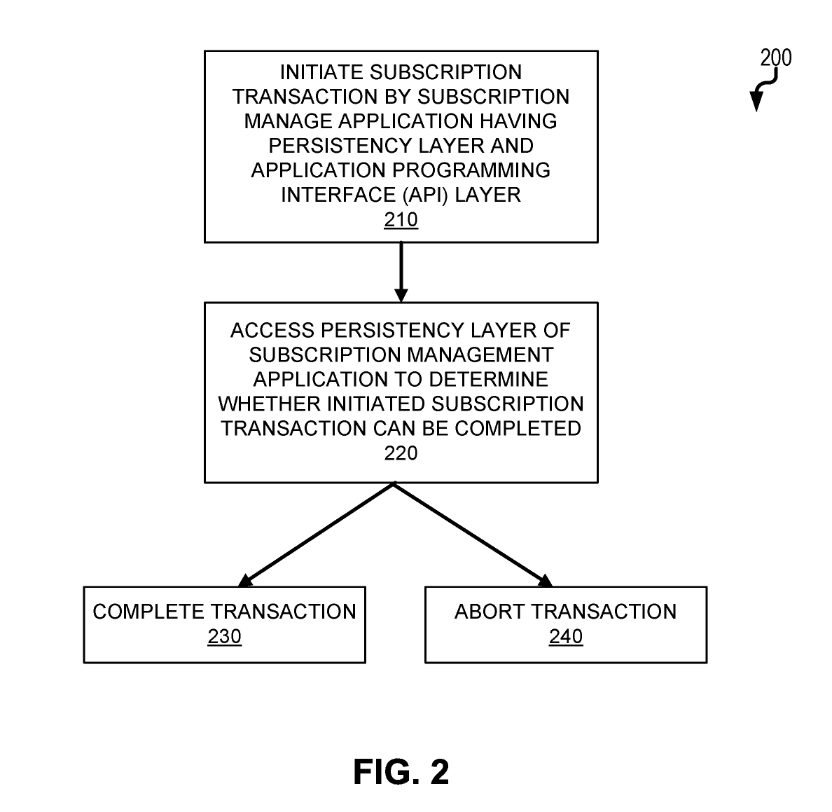

FIG. 2 is a process flow diagram 200 in which, at 210, a subscription management application initiates a subscription transaction. The subscription management application comprises a persistency layer and an application programming interface (API) layer. The persistency layer is configured to store information about a subscription associated with the subscription transaction originating from a subscription blockchain. The API layer is configured to retrieve information from the subscription blockchain and to update the subscription blockchain in connection with the subscription transaction. After the subscription transaction has been initiated, at 220, the persistency layer of the subscription management application is accessed to determine, in real-time, whether the initiated subscription transaction can be completed. After such determination, at 230, the subscription transaction is completed if it is determined that the initiated subscription can be completed or, at 240, the subscription transaction is aborted if it is determined that the initiated subscription cannot be completed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, can include machine instructions for a programmable processor, and/or can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, solid-state storage devices, memory, and Programmable Logic Devices (PLDs), used to provide machine instructions and/or data to a programmable data processor, including a machine-readable medium that receives machine instructions as a computer-readable signal. The term “computer-readable signal” refers to any signal used to provide machine instructions and/or data to a programmable data processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, such as for example as would a processor cache or other random access memory associated with one or more physical processor cores.

The computer components, software modules, functions, data stores and data structures described herein can be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality can be located on a single computer or distributed across multiple computers depending upon the situation at hand.

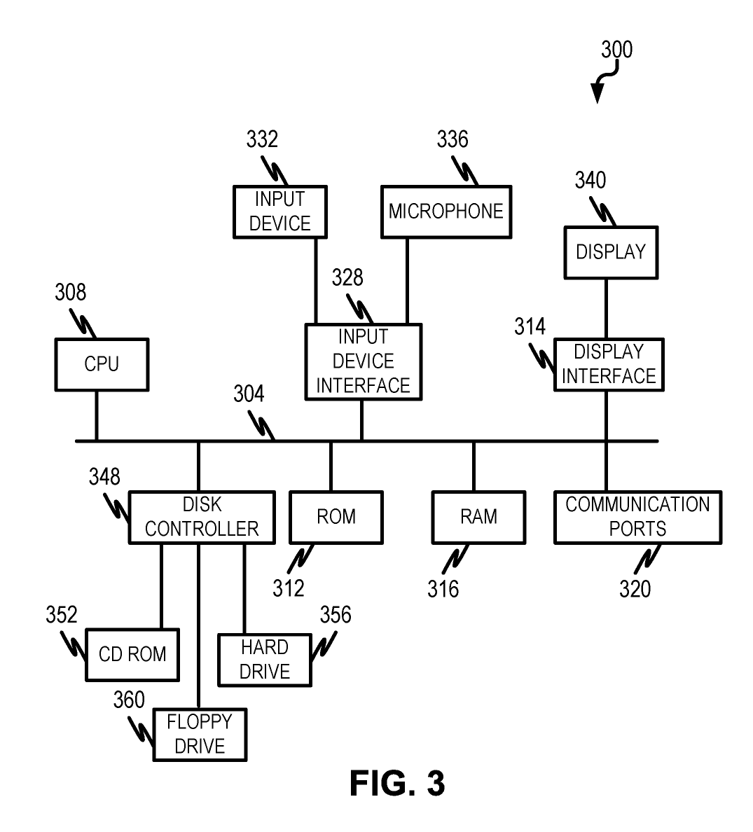

FIG. 3 is a diagram 300 illustrating a sample computing device architecture for implementing various aspects described herein. A bus 304 can serve as the information highway interconnecting the other illustrated components of the hardware. A processing system 308 labeled CPU (central processing unit) (e.g., one or more computer processors/data processors at a given computer or at multiple computers), can perform calculations and logic operations required to execute a program. A non-transitory processor-readable storage medium, such as read only memory (ROM) 312 and random access memory (RAM) 316, can be in communication with the processing system 308 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 348 can interface one or more optional disk drives to the system bus 304. These disk drives can be external or internal floppy disk drives such as 360, external or internal CD-ROM, CD-R, CD-RW or DVD, or solid state drives such as 352, or external or internal hard drives 356. As indicated previously, these various disk drives 352, 356, 360 and disk controllers are optional devices. The system bus 304 can also include at least one communication port 320 to allow for communication with external devices either physically connected to the computing system or available externally through a wired or wireless network. In some cases, the communication port 320 includes or otherwise comprises a network interface.

To provide for interaction with a user, the subject matter described herein can be implemented on a computing device having a display device 340 (e.g., a CRT (cathode ray tube) or LCD (liquid crystal display) monitor) for displaying information obtained from the bus 304 to the user and an input device 332 such as keyboard and/or a pointing device (e.g., a mouse or a trackball) and/or a touchscreen by which the user can provide input to the computer. Other kinds of input devices 332 can be used to provide for interaction with a user as well; for example, feedback provided to the user can be any form of sensory feedback (e.g., visual feedback, auditory feedback by way of a microphone 336, or tactile feedback); and input from the user can be received in any form, including acoustic, speech, or tactile input. In the input device 332 and the microphone 336 can be coupled to and convey information via the bus 304 by way of an input device interface 328. Other computing devices, such as dedicated servers, can omit one or more of the display 340 and display interface 324, the input device 332, the microphone 336, and input device interface 328.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, the current subject matter is applicable to the storage or other access of data via a cloud-based data storage service. The current subject matter is also applicable to the consumption of utilities such as electricity (e.g., use of an electric vehicle charging station by a subscription holder, etc.). In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer implemented method comprising:
initiating, by a subscription management application, a subscription transaction, the subscription management application comprising a persistency layer and an application programming interface (API) layer, the persistency layer being configured to store information about a subscription associated with the subscription transaction originating from a subscription blockchain, the API layer being configured to retrieve information from the subscription blockchain and to update the subscription blockchain in connection with the subscription transaction;
accessing the persistency layer of the subscription management application to determine, in real-time, whether the initiated subscription transaction can be completed;
completing the subscription transaction if it is determined that the initiated subscription can be completed or aborting the subscription transaction if it is determined that the initiated subscription cannot be completed.

2. The method of claim 1 further comprising:
updating, after the completion of the subscription transaction, the subscription blockchain to reflect completion of the subscription transaction.

3. The method of claim 1, wherein each block of the blockchain after an initial block comprises a hash or a reference to a hash of an immediately previous block in the block chain.

4. The method of claim 1 further comprising:
accessing, by the subscription management application by way of the API layer, a plurality of APIs of the blockchain to update the persistency layer with subscription information.

5. The method of claim 1, wherein the persistency layer indicates a current balance for an account associated with the subscription transaction.

6. The method of claim 1, wherein the persistency layer indicates a status of an account associated with the subscription transaction.

7. The method of claim 1, wherein the persistency layer indicates an authorization for an account associated with the subscription transaction.

8. The method of claim 1, wherein the persistency layer provides access to at least one database storing a plurality of tables, each table characterizes at least one related subscription transaction.

9. The method of claim 1, wherein the subscription transaction comprises use of a mobile phone to initiate a phone call over a wireless communications network.

10. The method of claim 1, wherein the subscription transaction comprises data use by a mobile phone over a wireless communications network.

11. The method of claim 1, wherein the subscription transaction comprises initiating a message by a mobile phone over a wireless communications network.

12. The method of claim 1, wherein the subscription transaction comprises store of data by a cloud-based data service.

13. The method of claim 1, wherein the subscription transaction comprises use of a resource by a utility.

14. A system comprising:
at least one programmable data processor; and
memory storing instructions which, when executed by at least one data processor forming part of at least one computing device, result in operations comprising:
initiating, by a subscription management application, a subscription transaction, the subscription management application comprising a persistency layer and an application programming interface (API) layer, the persistency layer being configured to store information about a subscription associated with the subscription transaction originating from a subscription blockchain, the API layer being configured to retrieve information from the subscription blockchain and to update the subscription blockchain in connection with the subscription transaction;
accessing the persistency layer of the subscription management application to determine, in real-time, whether the initiated subscription transaction can be completed;
completing the subscription transaction if it is determined that the initiated subscription can be completed or aborting the subscription transaction if it is determined that the initiated subscription cannot be completed.

15. The system of claim 14, wherein the operations further comprise:
accessing, by the subscription management application by way of the API layer, a plurality of APIs of the blockchain to update the persistency layer with subscription information; and
updating, after the completion of the subscription transaction, the subscription blockchain to reflect completion of the subscription transaction; and

16. The system of claim 14, wherein each block of the blockchain after an initial block comprises a hash or a reference to a hash of an immediately previous block in the block chain.

17. The system of claim 14 wherein the persistency layer indicates a current balance for an account associated with the subscription transaction, a status of an account associated with the subscription transaction, and an authorization for an account associated with the subscription transaction.

18. The system of claim 14, wherein the persistency layer provides access to at least one database storing a plurality of tables, each table characterizes at least one related subscription transaction.

19. The system of claim 14, wherein the subscription transaction comprises at least one of: use of a mobile phone to initiate a phone call over a wireless communications network, use by a mobile phone over a wireless communications network, or initiating a message by a mobile phone over a wireless communications network.

20. A non-transitory computer program product storing instructions which, when executed by at least one data processor forming part of at least one computing device, result in operations comprising:
initiating, by a subscription management application, a subscription transaction, the subscription management application comprising a persistency layer and an application programming interface (API) layer, the persistency layer being configured to store information about a subscription associated with the subscription transaction originating from a subscription blockchain, the API layer being configured to retrieve information from the subscription blockchain and to update the subscription blockchain in connection with the subscription transaction;
accessing the persistency layer of the subscription management application to determine, in real-time, whether the initiated subscription transaction can be completed;
completing the subscription transaction if it is determined that the initiated subscription can be completed or aborting the subscription transaction if it is determined that the initiated subscription cannot be completed.
